(19) United States
(12) Patent Application Publication
(10) Pub. No.: US 2017/0024801 A1
(43) Pub. Date: Jan. 26, 2017

(54) SYSTEM AND METHOD FOR LIST REORDERING BASED ON FREQUENCY DATA OR MICRO-LOCATION

(71) Applicant: Coupgon Inc., Toronto (CA)

(72) Inventors: Francesco Sinopoli, Brampton (CA); Justin Simpson, Toronto (CA)

(21) Appl. No.: 15/215,699

(22) Filed: Jul. 21, 2016

Related U.S. Application Data
(60) Provisional application No. 62/195,100, filed on Jul. 21, 2015.

(51) Int. Cl. G06Q 30/06; H04B 17/318; G06F 3/0482; G06F 17/30; G06F 3/0488; H04W 4/00; H04W 4/02

(52) U.S. Cl. CPC G06Q 30/0633; H04W 4/008; H04B 17/318; H04W 4/021; G06F 17/30699; G06F 3/04883; G06F 3/0482

(57) ABSTRACT

A system and method for list ordering based on frequency data or location is disclosed. The disclosed system and method can allow a user of a mobile device to quickly and efficiently add new items to a list by providing an ordered list of possible items from which the user selects. The list of possible items is ordered using frequency data to provide the most relevant items first based on item-to-item correlation, category correlation, and overall frequency. The list can also be reordered according to micro-location, such as that determined by using micro-location based sensor technology devices, to order the items by the shortest distance away from the mobile device.

### FIELD

The present disclosure relates generally to a method for improved list entry and list ordering on a mobile device having a touchscreen interface.

### BACKGROUND

Data entry on mobile devices with touchscreen interfaces can be a cumbersome process. Common techniques rely on using some form of an on-screen keyboard or handwriting recognition. Commonly, these approaches are used alongside predictive text or autocomplete algorithms that can refer to a dictionary of commonly used words. These approaches ignore the context of the data entry and are not especially helpful. For example, a user adding items to a grocery list maybe be provided with a number of autocomplete options that do not relate to grocery store items.

Indoor navigation with mobile devices can be difficult problem that requires a higher degree of resolution compared to GPS or other known methods. It can be difficult for a mobile device user to determine an efficient route or locate nearby items, such as in the context of a store or warehouse, when the user has a list of indoor waypoints or items.

### SUMMARY

According to a first aspect, a method is provided for entering items on a list stored on a mobile device having a touchscreen interface. The method comprises receiving a letter input on the touchscreen interface; obtaining a list of possible items based on letter input from an item database; reordering the list of possible items into an ordered list based on frequency data; providing the ordered list of possible items on the touchscreen interface; and obtaining a selected item from the touchscreen interface to add to the list.

The letter input can be received as a trace out of a letter on the touchscreen interface, and processing the trace out can use hand-writing recognition to determine the letter input. The letter input can be one or more potential letters and the frequency data can include hand-writing recognition weightings to ascribe a weighting to the one or more potential letters.

The frequency data can be category frequency, item-to-item frequency, and overall item frequency. Category frequency can be used to provide a category weighting to each item in the list of possible items based on categories of previously entered list items whereby reordering items on the list of possible items that are correlated with the same category of previously entered list items are ordered higher on the list of possible items based on the category weighting. The categories can include food groups; meal types; locations within grocery store; grocery store aisle; or recipe.

The item-to-item frequency can be used to reflect the correlation between items and is used to provide an item-to-item weighting to each item in the list of possible items based on previously entered list items whereby reordering items in the list of possible items that are correlated with previously entered list items are ordered higher on the list of possible items based on the item-to-item weighting.

The overall item frequency can provide for how often an item has appeared on previous lists and is used to provide an overall frequency weighting to each item in the list of possible items based on previously entered list items whereby reordering items in the list of possible items that are frequently contained on previous lists are ordered higher on the list of possible items based on the overall frequency weighting. The item can be local, which is particular to a user's previously entered list items, or global, which is particular to many user's previously entered list items. The global item frequency can also be further subdivided according to geographic region; language; or culture.

In some aspects, the method can also include receiving subsequent letter input on the touchscreen interface, and the steps of obtaining the list of possible items is based on the letter input and the subsequent letter input. The selected item can also be used to update the frequency data.

In a second aspect, a method is provided for ordering list items on a mobile device based on proximity to the items within a store location. This method comprises determining a location of the mobile device on an indoor map; mapping the location to the indoor map that includes location of the list items; calculating a distance from the location of the mobile device to the location of each of the list items; and reordering the list items based on the calculated distance. Determining the location can include receiving one or more signals from corresponding micro-location based sensor devices, and can also include determining a signal strength of the signals. The micro-location based sensor devices can include such technology as Bluetooth beacons or other signal identifying devices, and the signal can include an identifier and a received signal strength.

Calculating the distance can be based on a Euclidean distance calculated from the indoor map or aisle proximity, based on how far away the aisle containing the item is from the mobile device.

In some aspects, the method can include providing directions on a display of the mobile device to a specified one of the list items. The specified list items can be a selected item that is selected by the user of the mobile device or an item having the shortest distance to the mobile device.

A previous location of the mobile device can be used to assist in determining the location of the mobile device. Evaluating inertial measurement data from the accelerometers on the mobile device against the previous location can be used to assist in determining the location.

### BRIEF DESCRIPTION OF THE DRAWINGS

For a better understanding of the various embodiments described herein and to show more clearly how they may be carried into effect, reference will now be made, by way of example only, to the accompanying drawings which show at least one exemplary embodiment, and in which:

FIG. 1 is a block diagram showing a mobile device communicating with a server computing device over a network;

FIG. 2 is a flowchart diagram showing a method of providing improved list entry on a mobile device using an item databased and frequency data;

FIG. 3 is a flowchart diagram showing a method of reordering a current list of items on a mobile device based on proximity to the item location;

FIG. 4 is a top plan view of a retail location having a number of radio beacons located on the shelves;

FIG. 5 is a top plan view of the mobile device and three nearest radio beacons from FIG. 4 with the signal strength from each radio beacon represented as ring; and

FIG. 6 is top plan view of a retail store location that can be captured as a Cartesian map and include item locations (as identified by the arrows).

### DESCRIPTION OF VARIOUS EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementations of various embodiments described herein.

The embodiments of the systems, devices and methods described herein may be implemented in hardware or software, or a combination of both. Some of the embodiments described herein may be implemented in computer programs executing on programmable computers, each computer comprising at least one processor, a computer memory (including volatile and non-volatile memory), at least one input device, and at least one output device. For example, and without limitation, the programmable computers may be a server class computer having multiple processors and at least one network interface. Program code may operate on input data to perform the functions described herein and generate output data.

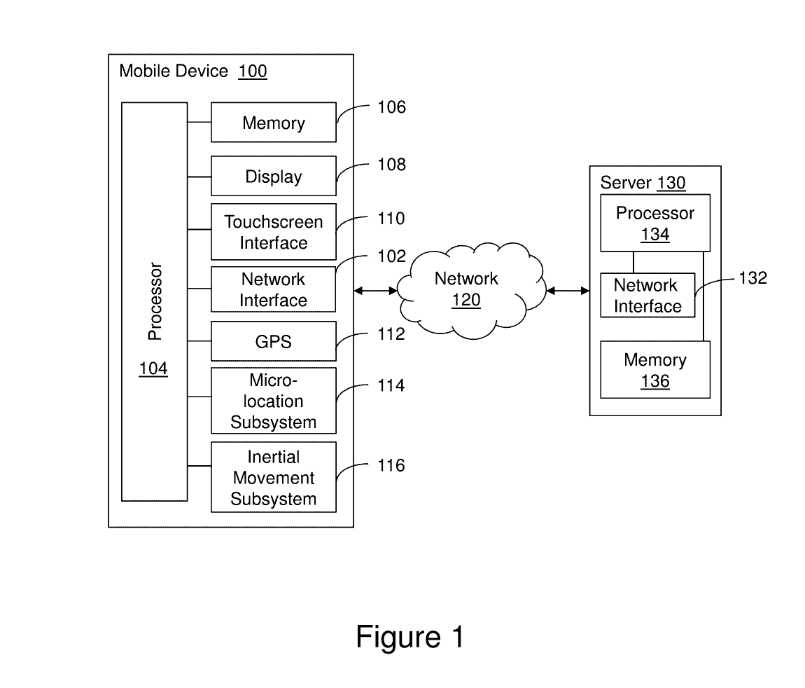

Reference is first made to FIG. 1, shown is a block diagram of a mobile device 100 that can communicate over a network with a server computing device. Mobile device 100 can include mobile computing devices such as mobile phones, tablet computers, or other hand held computing devices. Network 120 and network interfaces 102, 132 can include both wired and wireless, or a combination thereof. Network 120 can also include the internet. Both mobile device 100 and server 130 have a processor 104, 134 and memory 106, 136 for storing instructions and data. Stored instructions can be executed by a processor 104, 134 to carry out the methods described herein. In a preferred embodiment mobile device 100 has a display 108, touchscreen interface 110, a global positioning system (GPS) 112, a micro-location subsystem 114, and an inertial movement subsystem 116 that are coupled to processor 104. The term “touchscreen interface” can also be used to encompass both display 108 and touchscreen interface 110.

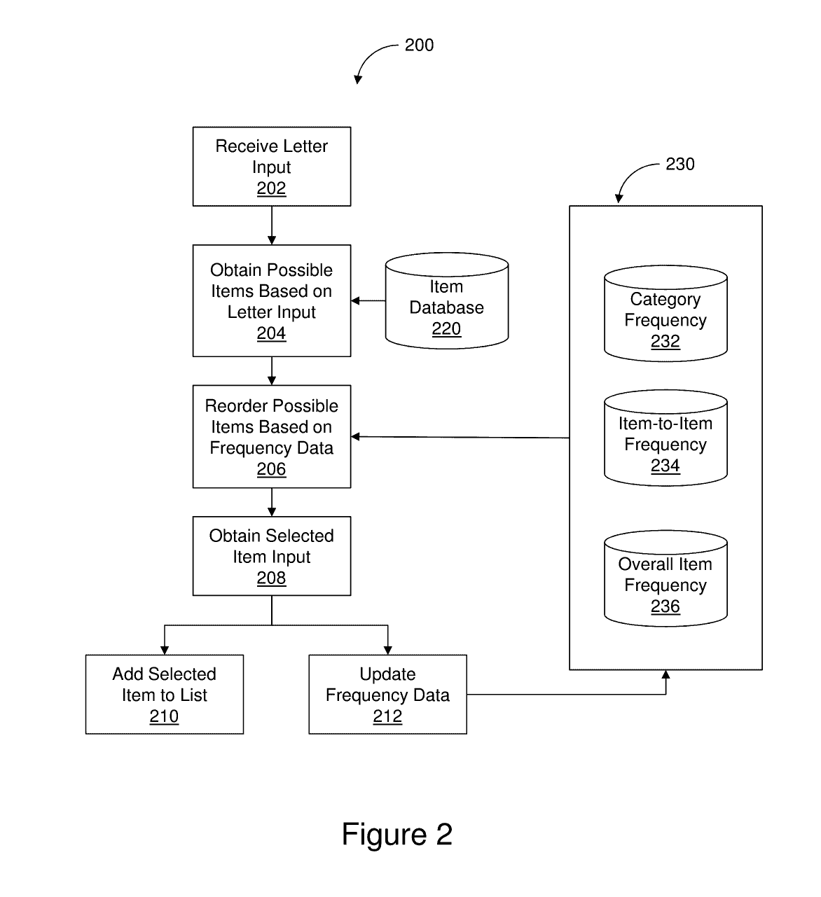

Reference is next made to FIG. 2, shown is a method 200 of providing improved list entry on mobile device 100. Method 200 allows a user of mobile device 100 to quickly and efficiently add new items to a list by providing an ordered list of possible items from which the user selects. The list can be a shopping list, a to-do list, chores list, or other type of data structure that contains a number of items, either ordered or unordered. Shopping list examples are provided in the embodiments described herein for illustration purposes. The list can be stored locally on mobile device 100, or can include a shared list stored on a network accessible server, such as to allow multiple mobile devices to access the same list.

First, at step 202, mobile device 100 receives a letter input from touch screen interface. Mobile device 100 can receive multiple letters input in sequence with method 200 iteratively improving the suggested items based on sequentially entered letters by repeating step 204 to truncate the list while maintaining the ordering determined in step 206.

Preferably, step 202 receives letter input based on a hand-writing recognition. For example, mobile device 100 can have a touch interface that allows the user to trace out the desired letter on the display screen. Letter input in this method can allow for some uncertainty in letter entry such that it may not be clear what letter has been entered. For example, it may be uncertain whether a user has entered an “e” or a “c”. Mobile device 100 can provide a weighting to each potentially entered letter and adjust these weightings as they are corrected by the user's selection of the desired item in order to “learn” a user's handwriting style. Other known methods of handwriting recognition and learning can also be used.

Next, at step 204, a list of possible items is obtained from item database 220 based on the received letter input from step 202. Item database 220 can be stored locally on mobile device 100 and contain all possible items for list entry. Item database 220 can also be located on a network accessible server that mobile device 100 can access directly or from which a locally stored item database 220 can be periodically updated. Item database 220 can be updated by the user to add their own particular items. In a grocery list example, the item database 220 can contain possible grocery items. For example, if a user has possibly entered an “e” or “c” then in step 204 the processor of mobile device 100 will obtain all grocery items beginning with either the letters “e” or “c”.

At step 206 the list of possible items is reordered based on frequency data 230 in order to present the items most likely to be selected by the user at the top of the possible item list. Frequency data 230 is used to determine which items are most likely to be selected by the user for list entry and can include category frequency 232, item-to-item frequency 234, and overall item frequency 236. Frequency data 230 can correlate possible list items to previously entered list items based on category pairings, item pairings, or overall item frequency to provide an improved ordering of the list of possible items presented to the user by mobile device 100 for selection.

Frequency data 230 can be stored locally on mobile device 100, a network accessible server, or a combination thereof. In some embodiments locally stored frequency data 230 can be updated periodically from frequency data 230 obtained from multiple users. Frequency data 230 from multiple users can include frequency data from users that update the same list. For example, frequency data can be acquired from both spouses that update their shared grocery list.

Frequency data 230 can be global, based on all users of method 200, or local, based on single user of mobile device 100, and in some embodiments both local and global frequency data 230 can be used. For example, overall item frequency 236 can include both how often a particular user selects a particular item and can also include how often the global user base selects a particular item. Global frequency data can also be subdivided further by geographic region, language of user, cultural or ethnic background, or in such other manner to provide improved suggestion based on one or more characteristic of the user.

Frequency data 230 can also include hand-writing recognition weightings that can be used to ascribe a weighting to a possible letter entered by the user, such as the likelihood that the user has entered an “e” versus a “c” in the example above.

Category frequency 232 relies on items having one or more associated categories and correlating possible list items by category with previously entered list items. Category frequency 232 can be obtained by analyzing one or more user's past list entry inputs to make relevant connections between categories based on the frequency at which these categories appear on the same list together. Categories are used to determine what other categories may pair well with one or more items previously entered in the list.

Item categories that are highly correlated with previously entered list items can provide a higher weighting to items of these categories so that they are presented higher in the list of possible items for user selection. In the grocery list example, categories can include food groups (e.g. dairy, vegetable, fruit, grains, etc.), meal type (e.g. breakfast, lunch, snack foods), or general location in a grocery store (e.g. produce, fish, deli, meat, sundry). Preferably, previously entered list items that are used to correlate with categories are from a current list that the user is populating, however, some embodiments can also use a past list that the user has made, possibly providing lower weighting to older lists.

In some embodiments, categories can also include recipes such that all items belonging to a certain recipe are in the same category. For example, if a user had previously entered “rice noodles” which belonged to the “Pad Thai recipe” category, then other possible items belonging to the “Pad Thai recipe” category would be more highly correlated and this correlation would increase as the user selected other items belonging to the same recipe category.

Item-to-item frequency 234 can be obtained by analyzing one or more user's past list entry inputs to make relevant connections between items. For example, every time peanut butter and jam are purchased together, the item-to-item frequency connection between peanut butter and jam is increased. A higher item-to-item frequency correlation of a possible list item to previously entered list items will provide a higher weighting to that possible list item to order it higher in the list of possible items presented to the user for selection.

Overall item frequency 236 provides a list frequency value for each item. The overall item frequency 236 can provide how many times the item has appeared on the user's previous lists and can also provide how many times the item has appeared on all users lists. The overall item frequency from the user's previous lists can have a higher weighting than the global overall item frequency from all users.

If a user has a number of previous lists that contain the same item, then that item would be promoted higher in the list of possible items according to the user's local overall item frequency. For example, if a user has four previous lists that contain the item ‘Peanut Butter’ and two lists that contain the item ‘Pickles’, the item ‘Peanut Butter’ will have a higher list frequency value than the ‘Pickle’ item. Assuming the user begins by writing the letter ‘P’, both items, ‘Peanut Butter’, and ‘Pickles’ would be valid suggestions, however, since ‘Peanut Butter’ has a higher list frequency value than ‘Pickles’, ‘Peanut Butter’ would be returned and displayed higher in the list of possible items than ‘Pickles’.

Overall item frequency 236 can provide a weighting for each item based on the overall frequency that the item is added to a list by any user. For example, if 5,000 users have all added the item ‘Peanut Butter’ to three of their lists, then the overall frequency value of ‘Peanut Butter’ would be 15,000. If the item ‘Potato’ has been added by 3,500 users to two different lists, then the overall frequency value of ‘Potato’, would be 7,000. In the case that the user inputs the letter ‘P’ in step 202, both ‘Potato’ and ‘Peanut Butter’, would be valid and displayed on the list of possible items, however ‘Peanut Butter’ would be placed higher on the list because it has a larger weight value than ‘Potato’.

In step 206, each of the frequency data 230 can be used in combination with each different type of frequency data 230 having a different weighting. For example, the local user's overall item frequency 236 can provide a high weighting, the user's item-to-item frequency 234 can also provide a high weighting, global users item-to-item frequency 234 can provide a moderate weighting, and the global users category frequency 232 can provide a lower weighting. In this example, the local user's past overall frequency 236 and item-to-item frequency 234 provide a higher relevancy to the ordering of the possible list items compares to the other frequency data 230.

The list of possible items can be presented on the display of mobile device 100 after reordering in step 206. Other embodiments can dynamically update the displayed list as the frequency data 230 is applied to reorder the possible list of items. For example, the user's local frequency data 230 can be applied first and global frequency data 230 can be applied as it is received from the server.

At step 208, mobile device 100 obtains a selected item input from the ordered list of possible items. A user of mobile device 100 can select a possible item using the touch screen interface and tapping a desired item in the list of possible items shown on the display. The selected item is then added to the current list in step 210. The selected item from step 208 is also used to update the frequency data 230 in step 212. Updating frequency data 212 can include updating the local user's frequency data on mobile device 100 or updating global frequency data 230 stored on a network connected server.

The following provides an example of method 200 of providing improved list entry on a mobile device for a grocery list. Mobile device 100 first receives a letter input from a user writing a letter “P” on the touch screen interface. Next, in step 204, mobile device 100 obtains the following list of possible items from item database 220:

Parsley

Peas

Peanut Butter

Pear

Pepper

Pickles

Pineapple

Potato

Mobile device 100 next reorders the list of possible items based on frequency data 230 in step 206. Accordingly, one potential reordered possible item list can be as follows:

Peanut Butter (highest overall global frequency and user frequency)

Pickles (second largest user frequency)

Potato (second largest overall global frequency)

Parsley

Peas

Pear

Pepper

Pineapple

Mobile device 100 can receive a second letter, for example, if the user wrote the letter ‘e’ on the mobile device. Step 204 would then truncate the list of possible items to remove items that did not include “e” as the second letter as follows:

Peanut Butter

Peas

Pear

Pepper

The above list of possible items is still ordered based on all previously defined values from frequency data 230, and is also filtered based on the two letters received by the mobile device, “Pe”. If the user then wrote ‘p’, the list of possible items would be truncated further to only include the item “Pepper”. After selection by the user of mobile device, “Pepper” would be added to the current list and the frequency data 230 would be updated to reflect the selection of “Pepper”. A user can select an item for list entry after the first letter entry or after subsequent letter entry.

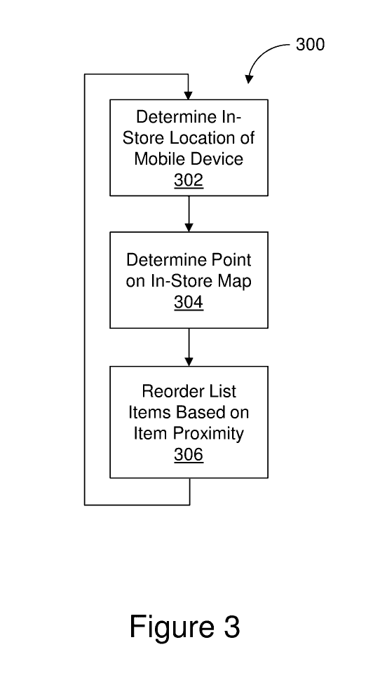

Reference is next made to FIG. 3, shown is a method 300 for reordering the current list of items on mobile device 100 based on proximity to the items. Reordering of the list items can use micro-location based sensor technology devices that are placed throughout a location. The preferred embodiment described herein refers to an in-store location but other embodiments of method 300 could apply to residential, commercial or other indoor locations using an indoor map. In addition to the micro-location technology, other location based technology can also be used, such as GPS, Wi-Fi-based location services, cell phone tower based location, and various device sensors, such as accelerometers.

At step 302, mobile device 100 determines its in-store location. In a grocery list example, retail locations can be mapped out on an indoor map and the maps can then be digitally marked to define in-store locations of various items and categories. The indoor maps can also be digitally marked using micro-location based sensor technology that broadcasts radio signals (such as Bluetooth for example) that are placed throughout the retail location (e.g. on shelves in aisles). An example of a micro-location sensor technology can be a radio beacon that broadcasts a unique identifier. The unique identifier that can then be used as an anchor point on a digital map that corresponds to points in the physical store. These points are later used in aiding detection of the location of mobile device 100 within the store.

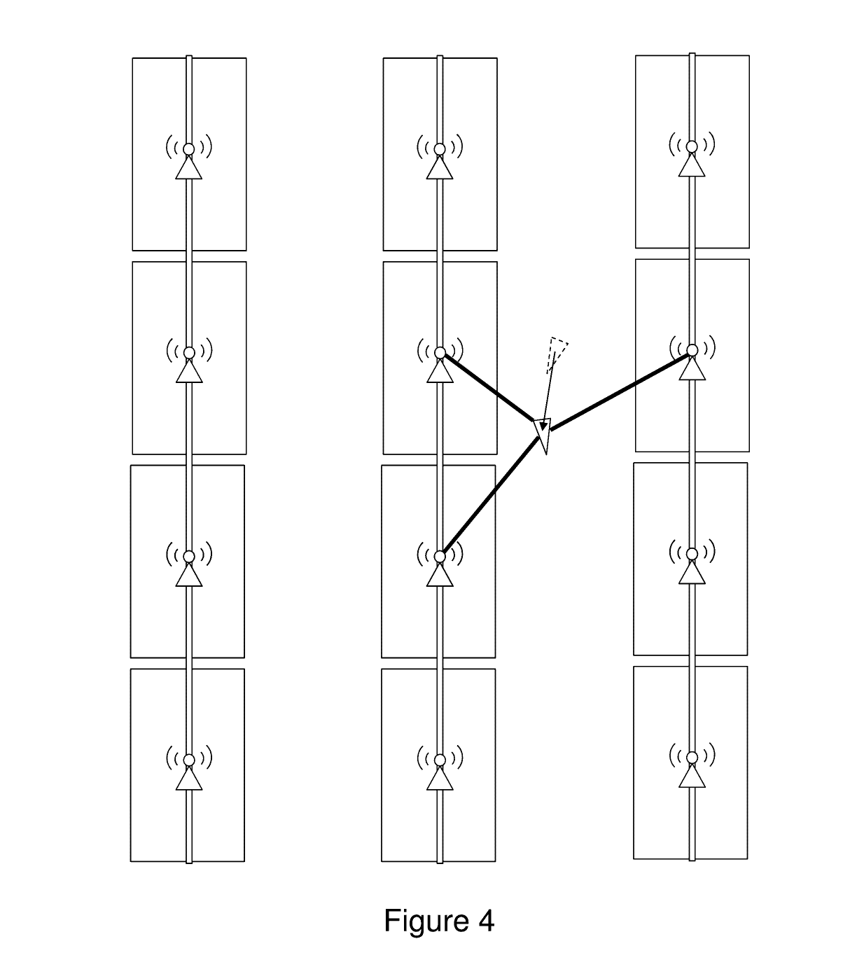

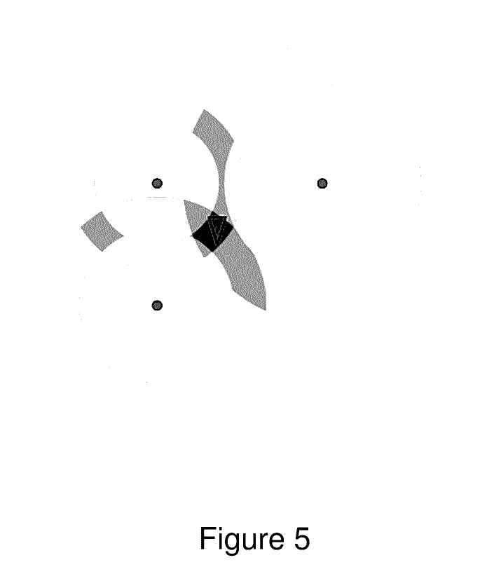

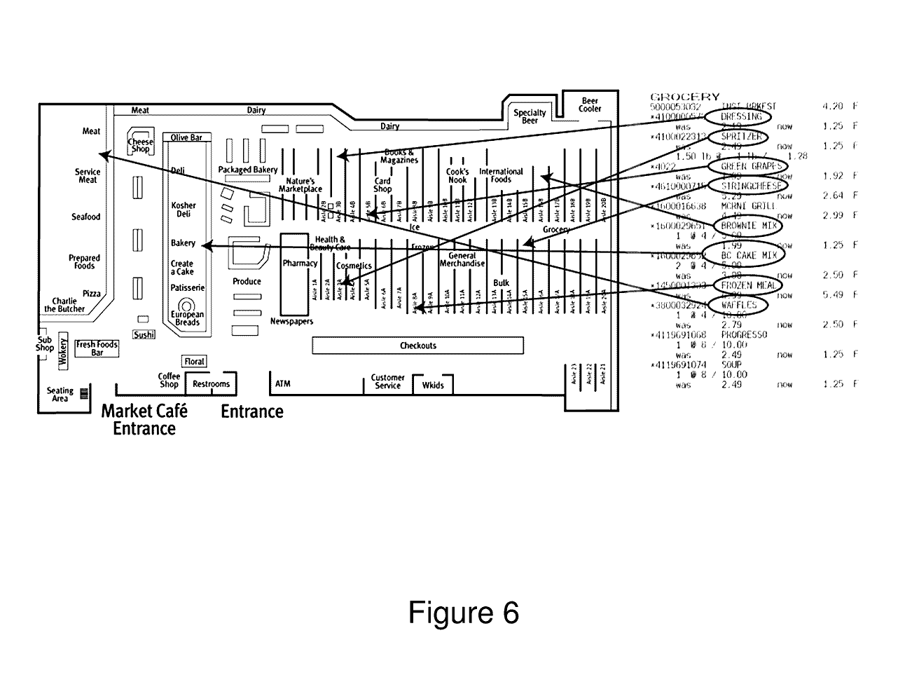

An example retail location is shown in FIG. 4 with three shelving aisles having a number of radio beacons affixed to the shelves. Mobile device 100, as indicated by the solid triangle, can determine its position based on signal strength (or any other ranging and/or angulating methods known for determining location) from one or more of the micro-location based sensor technology devices. This concept is further illustrated in FIG. 5 showing the range of the mobile device to each of the micro-location based sensor technology devices from FIG. 4. Each ring in FIG. 4 corresponds to a certain signal strength (or distance) from the corresponding radio beacon. FIG. 6 provides a general example of an indoor map that maps items to in-store locations that can be used to provide general Cartesian placement information with respect to the micro-location sensor devices through a store mapping process. This Cartesian mapping can also be done by category, either separately or in addition to the by-item mapping.

Micro-location based sensor devices can also communicate with mobile device 100 to provide information on how far away mobile device 100 is from the micro-location based sensor device. Estimations for the user's mobile device's general location can then made based on varying factors.

For example, some of the factors used in step 302 can include: (i) the distance to all micro-location based sensor devices that are currently in range of mobile device 100, (ii) inertial measurement data (such as a specific force, angular rate, orientation and gravitational forces) provided by the inertial movement subsystem of the mobile device, (iii) the general Cartesian placement information setup from the store mapping process to determine where micro-location based sensors are relative to each other, and (iv) the previous data regarding the location of mobile device 100.

Using any one or more of these factors, an estimate of the position of mobile device 100 on the Cartesian representation of the store's map can be made from the distance to varying micro-location based sensors. Inertial measurement data can also be cross-referenced to determine if the current estimate of the mobile device position is feasible given the moment and direction the mobile device and past in-store location. If the current estimate is not feasible, the estimate can be corrected to more closely reflect the inertial measurement data that has been recorded, while attempting to balance in distances from the previously used micro-location based sensor data. Once the location of the mobile device is determined, it is stored and used to reference and gauge the potential accuracy of the next location determination. These logged points can then be used to further validate any future estimates that are made based on both micro-location based sensor data and inertial measurement data.

In some embodiments, the micro-location based sensor technology device can be capable of transmitting their Received Signal Strength Indicator (RSSI) value in addition to other data. This RSSI value can be calibrated by the manufacturer of the device to be the signal strength from the device at a known distance, typically one meter. Using the known output signal strength of the micro-location based sensor technology device and the signal strength observed by the receiving mobile device an approximation can be made about the distance between the micro-location based sensor technology device and the mobile device. Using multiple RSSI values can further help to locate mobile device with respect to the known position of the micro-location based sensor technology devices.

Next, at step 304, the in-store location estimate from step 302 can be converted to a point on the Cartesian map of the store. The location can have a radius of uncertainty emitting outwards. In step 306, all items on the current list of mobile device 100 are then ordered based on the estimated proximity of mobile device 100 to either the absolute placement of the item defined on the map, or the location of the item's category, as plotted on the map. The estimated proximity can be calculated based on the distance on the Cartesian map (such as the Euclidean distance), and can also include aisle proximity, based on whether the item is in the current aisle or how many aisles away from the current aisle.

In some embodiments, mobile device 100 can receive the selection of a particular item on the list and mobile device 100 can provide directions. The directions can include the aisle number or other location information provided to the user to help locate the item in the store. Using steps 302 and 304, mobile device 100 can ascertain its position relative to the selected particular item. Mobile device 100 could further provide directions, such as directional arrows or an aisle number on the display to direct the user of mobile device 100 to a location of the selected item from the list. Mobile device 100 can also constantly be providing directions to the item that is located the shortest distance away.

Some embodiments can also help a user identify if there are any applicable discounts, rebates, coupons, or sales for any item that is included in the current list on mobile device 100. Retailers, manufacturers, or producers may provide savings for the items on the current list. Where applicable, mobile device 100 can identify various promotions that are tied to the items in the current list, provide visual indicia of said promotion associated with the item, and allow the user (through mobile device 100) to receive promotional offers and/or digitally clip the saving into a stored wallet on their mobile device. At check-out, the user can redeem their savings to the point of sale system through mobile device 100.

While the exemplary embodiments have been described herein, it is to be understood that the invention is not limited to the disclosed embodiments. The invention is intended to cover various modifications and equivalent arrangements included within the spirit and scope of the appended claims, and scope of the claims is to be accorded an interpretation that encompasses all such modifications and equivalent structures and functions.

1. A method for entering items on a list stored on a mobile device having a touchscreen interface, the method comprising:
receiving a letter input on the touchscreen interface;
obtaining a list of possible items based on letter input from an item database;
reordering the list of possible items into an ordered list based on frequency data;
providing the ordered list of possible items on the touchscreen interface; and
obtaining a selected item from the touchscreen interface to add to the list.

2. The method of claim 1 wherein receiving a letter input comprises receiving a trace out of a letter on the touchscreen interface; and processing the trace out using hand-writing recognition to determine the letter input.

3. The method of claim 2 wherein the letter input comprises one or more potential letters and the frequency data includes hand-writing recognition weightings to ascribe a weighting to the one or more potential letters.

4. The method of claim 1 wherein the frequency data is any one or more of category frequency, item-to-item frequency, and overall item frequency.

5. The method of claim 4 wherein the category frequency is used to provide a category weighting to each item in the list of possible items based on categories of previously entered list items whereby reordering items on the list of possible items that are correlated with the same category of previously entered list items are ordered higher on the list of possible items based on the category weighting.

6. The method of claim 5, wherein the categories include any one or more of food groups; meal types; locations within grocery store; grocery store aisle; and recipe.

7. The method of claim 4 wherein the item-to-item frequency reflects the correlation between items and is used to provide an item-to-item weighting to each item in the list of possible items based on previously entered list items whereby reordering items in the list of possible items that are correlated with previously entered list items are ordered higher on the list of possible items based on the item-to-item weighting.

8. The method of claim 4 wherein the overall item frequency provides for how often an item has appeared on previous lists and is used to provide an overall frequency weighting to each item in the list of possible items based on previously entered list items whereby reordering items in the list of possible items that are frequently contained on previous lists are ordered higher on the list of possible items based on the overall frequency weighting.

9. The method of claim 8 where item frequency is any one or more of local, particular to a user's previously entered list items, and global, particular to many user's previously entered list items.

10. The method of claim 9 wherein global item frequency is subdivided according to any one of geographic region; language; and culture.

11. The method of claim 1 further comprising receiving subsequent letter input on the touchscreen interface, wherein obtaining the list of possible items is based on the letter input and the subsequent letter input.

12. The method of claim 1 where the selected item is used to update the frequency data.

13. A method of ordering list items on a mobile device based on proximity to the items within an indoor location, the method comprising:
determining a location of the mobile device on an indoor map;
mapping the location to the indoor map that includes location of the list items;
calculating a distance from the location of the mobile device to the location of each of the list items; and
reordering the list items based on the calculated distance.

14. The method of claim 13 wherein determining the location comprises receiving one or more signals from corresponding micro-location based sensor devices.

15. The method of claim 14 further comprises determining a strength of the one or more signals.

16. The method of claim 15, wherein the micro-location based sensor devices are Bluetooth beacons.

17. The method of claim 16, where the signals from the Bluetooth beacons comprises an identifier and a received signal strength.

18. The method of claim 13 where calculating the distance is based on any one or more of a Euclidean distance or aisle proximity.

19. The method of claim 13 further comprising providing directions on a display of the mobile device to a specified one of the list items.

20. The method of claim 19, wherein the specified one of the list items is any one of a selected item and an item have the shortest distance to the mobile device.

21. The method of claim 13 further comprises storing a previous location of the mobile device and using the previous location in determining the location of the mobile device.

22. The method of claim 21 wherein determining the location of the mobile device further comprises evaluating inertial measurement data against the previous location.
